(19) United States
(12) Patent Application Publication
(10) Pub. No.: US 2016/0161096 A1
(43) Pub. Date: Jun. 9, 2016

(54) LIGHTING ARRANGEMENT

(71) Applicant: CP IP Holdings Limited, Central Hong Kong (CN)

(72) Inventors: Dave Boulanger, Hong Kong (CN); Maciej Nowakowski, Hong kong (CN)

(21) Appl. No.: 14/956,416

(22) Filed: Dec. 2, 2015

Related U.S. Application Data
(60) Provisional application No. 62/086,820, filed on Dec. 3, 2014.

(51) Int. Cl. F21V 21/02; F21V 21/14

(52) U.S. Cl. CPC F21V 21/02; F21V 21/14

(57) ABSTRACT

A lighting arrangement can include a mounting ring and a luminaire. The mounting ring can extend along a central longitudinal axis and have a plurality of tabs, a circular wall, and a plurality of locking arms. Each of the plurality of tabs can define a mounting aperture and the circular wall can interconnect the plurality of tabs. Each of the plurality of locking arms can project from the circular wall and include a circumferential portion extending about the axis. The luminaire can have a housing assembly and a light emitter and a plurality of posts. The mounting ring and the luminaire can be interconnected by moving the posts past distal ends of the locking arms along the axis and then rotating the mounting ring and the luminaire relative to one another in a first angular direction about the axis.

### CROSS-REFERENCE TO RELATED APPLICATIONS

This application claims the benefit of U.S. Provisional Patent Application Ser. No. 62/086,820 for a LIGHTING ARRANGEMENT, filed on 3 Dec. 2014, which is hereby incorporated by reference in its entirety.

### BACKGROUND

1. Field

The present disclosure relates to structures operable to emit light.

2. Description of Related Prior Art

U.S. Pat. No. 8,376,777 discloses a QUICK MOUNTING DEVICE WITH MODULES. The quick mounting device for appliances is alleged to be quickly and easily engaged and disengaged mechanically without the use of tools.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A lighting arrangement can include a mounting ring and a luminaire. The mounting ring can extend along a central longitudinal axis and have a plurality of tabs. The mounting ring can also have a circular wall and a plurality of locking arms. Each of the plurality of tabs can define a mounting aperture. The circular wall can interconnect the plurality of tabs. The circular wall can have an inwardly-facing surface encircling the axis and defining a cavity. The circular wall can also have an outwardly-facing surface opposite the inwardly-facing surface with a thickness defined between the inwardly-facing surface and the outwardly-facing surface. The circular wall can extend a height along the axis between a downwardly-facing surface and an upwardly-facing surface. Each of the plurality of locking arms can project from the circular wall radially relative to the axis. Each of the plurality of locking arms can include a vertical portion extending along the axis and a circumferential portion extending about the axis. Each of the circumferential portions can extend from a first end at an intersection with one of the vertical portions to a respective second end distal relative to the first end. Each of the circumferential portions can have an upper face and a lower face. The luminaire can have a housing assembly and a light emitter and a plurality of posts. The housing assembly can at least partially enclose the light emitter. The housing assembly can at least partially be received in the cavity. Each of the plurality of posts can extend away from the housing assembly. The mounting ring and the luminaire can be interconnected by moving each of the plurality posts past each of the plurality of distal ends along the axis and rotating the mounting ring and the luminaire relative to one another in a first angular direction about the axis.

### BRIEF DESCRIPTION OF THE DRAWINGS

The detailed description set forth below references the following drawings:

FIG. 1 is a perspective view of a mounting ring according to an exemplary embodiment of the present disclosure;

FIG. 2 is a perspective view of a lighting assembly according to an exemplary embodiment of the present disclosure;

FIG. 3 is a perspective view of a mounting ring and covering ring according to an exemplary embodiment of the present disclosure;

FIG. 4 is a perspective view of a lighting arrangement according to an exemplary embodiment of the present disclosure;

FIG. 5 is a top view of a lighting assembly according to an exemplary embodiment of the present disclosure;

FIG. 6 is a top view of a mounting ring according to an exemplary embodiment of the present disclosure;

FIG. 7 is an exploded view of an exemplary embodiment of the present disclosure;

FIG. 8 is a perspective assembly view the exemplary embodiment of the present disclosure shown in FIG. 7;

FIG. 9 is a planar view of a locking arm of the exemplary embodiment of the present disclosure shown in FIG. 7 from the perspective of a central longitudinal axis;

FIG. 10 is a planar view of a locking arm of another exemplary embodiment of the present disclosure;

FIG. 11 is a planar view of a locking arm of another exemplary embodiment of the present disclosure; and

FIG. 12 is a planar view of a locking arm of another exemplary embodiment of the present disclosure.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide lighting arrangements that do not require an installer to make additional holes into the ceiling or wall mounting location. Lighting arrangements according to one or more embodiments of the present disclosure can attach directly into a standard junction box used in building construction. Lighting arrangements according to one or more embodiments of the present disclosure can be comprised of two main components that are attached together without the need for tools.

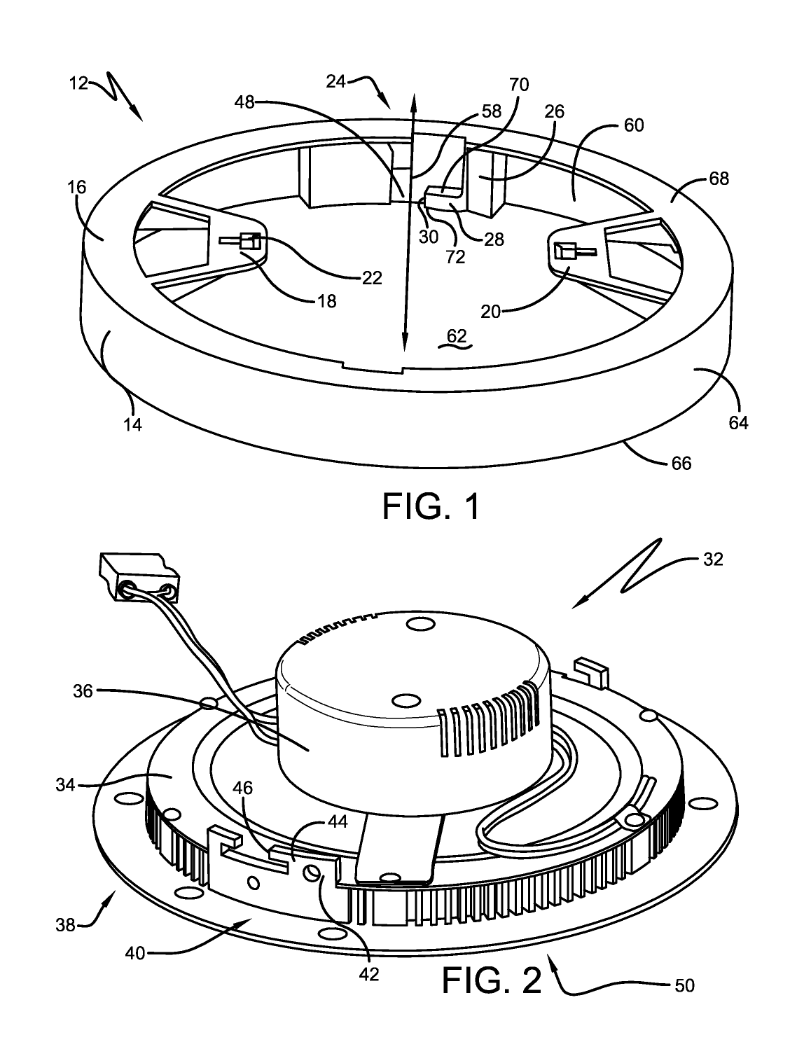

FIG. 1 is a perspective view of a mounting ring 12 according to an exemplary embodiment of the present disclosure. The mounting ring 12 can include a cylindrical portion or circular wall 14 and a disk portion 16. Mounting tabs projections 18, 20 can be engaged with the cylindrical portion 14 and the disk portion 16. The circular wall 14 can interconnect the plurality of tabs 18. Each mounting projection 18, 20 can include a mounting aperture, such as aperture 22, configured to receive a threaded fastener for attaching the mounting ring 12 to a junction box (not shown). The circular wall 14 can have an inwardly-facing surface 60 encircling the axis 58 and defining a cavity 62. The circular wall 14 can also have an outwardly-facing surface 64 opposite the inwardly-facing surface 60 with a thickness defined between the inwardly-facing surface 60 and the outwardly-facing surface 64. The circular wall 14 can extend a height along the axis 58 between a downwardly-facing surface 66 and an upwardly-facing surface 68.

The mounting ring 12 can also include one or more locking arms 24. The exemplary locking arms 24 projecting radially-inward from the inwardly-facing surface 60 of the cylindrical portion 14. The locking arm 24 can include a vertical portion 26 and a circumferential portion 28. Each of the plurality of circumferentially-extending locking arms 24 can project from the circular wall 14 radially relative to the axis 58. Each of the circumferential portions 28 can extend from a first end at an intersection with one of the vertical portions 26 to a respective second end 30 distal relative to the first end. Each of the circumferential portions 28 can have an upper face 70 and a lower face 72. Each face 70, 72 can be defined by a plurality of discrete surfaces in one or more implementations of the present disclosure.

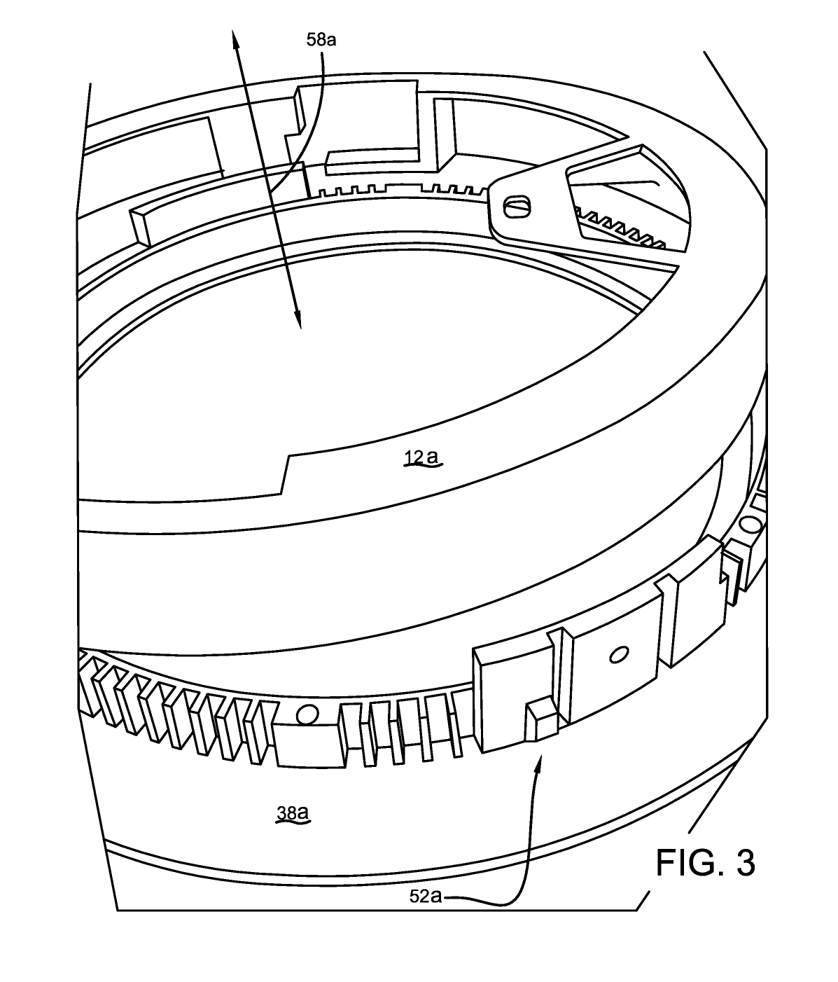

FIG. 2 is a perspective view of a lighting assembly or luminaire 32 according to an exemplary embodiment of the present disclosure. The lighting assembly 32 can include a housing assembly 34 containing light emitters and circuitry for powering the light emitters, including any power and ac/dc conversion circuitry. The circuitry can be mounted in a housing 36 attached to the housing assembly 34. The housing assembly 34 can also include a plurality of posts 40. Each of the plurality of posts 40 can extend away from the housing assembly 34. The housing 36 can be sized to fit within a junction box. The housing assembly 34 can be sized to at least partially be received in the cavity 62.

The plate 34 and housing 36 can be interconnected to one another through a covering ring 38 of the exemplary lighting assembly 32. The covering ring 38 define the posts 40. Each of the exemplary posts 40 can have a vertical portion 42 and a circumferential portion 44. The circumferential portion 44 projects transverse to the vertical portion 42 to a distal end 46.

After the mounting ring 12 has been mounted at the desired location for lighting, the lighting assembly 32 can be received in the cylindrical portion 14 to form a lighting arrangement. The mounting ring 12 and the luminaire 32 can be interconnected by moving each of the plurality posts 40 past each of the plurality of distal ends 30 along the axis 58 and rotating the mounting ring 12 and the luminaire 32 relative to one another in a first angular direction about the axis 58. The vertical portion 44 can be received in a gap referenced at 48. The lighting assembly 32 can then be rotated relative to the mounting ring 12 until the distal end 46 contacts the vertical portion 26 and/or until the distal end 30 contacts the vertical portion 42. The mounting ring 12 and the lighting assembly 32 are thus assembled for use and an exemplary lighting arrangement is formed. A surface referenced at 50 of the covering ring 38 conceals the mounting ring 12 from view.

FIG. 3 is a perspective view of a mounting ring 12a and a covering ring 38a according to an exemplary embodiment of the present disclosure. The hook portion 40 has been replaced with a hook portion 40a in the form of a tab. The hook portion 40a extends radially outward relative to an axis 58a, rather than along the axis 58 like the hook portion 40.

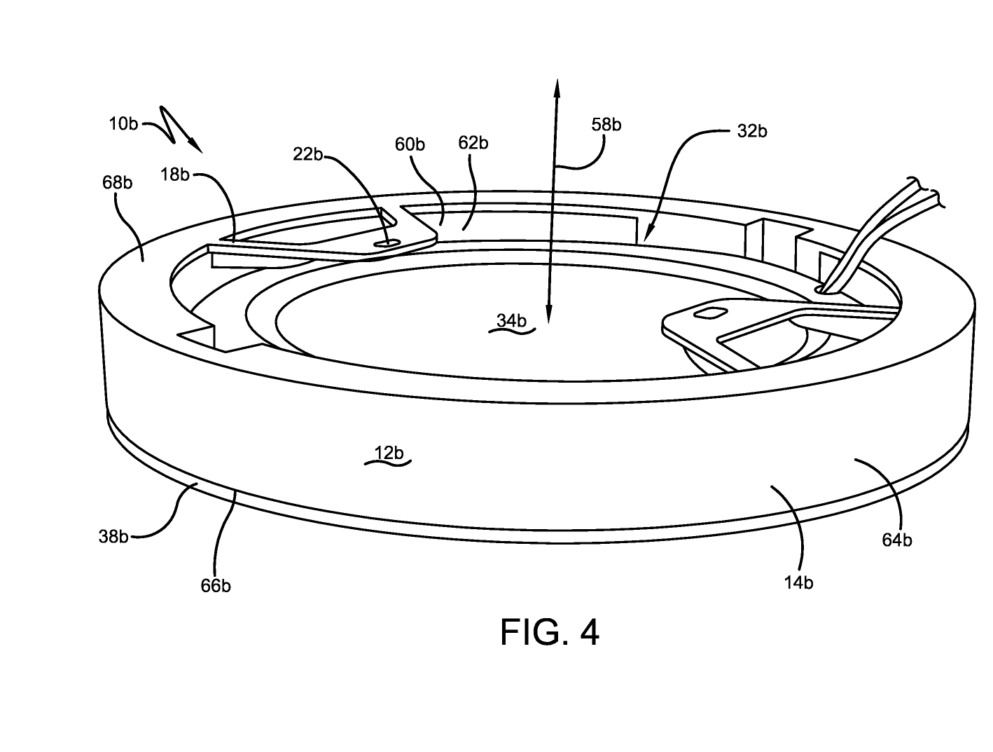

FIG. 4 is a perspective view of a lighting arrangement 10b according to an exemplary embodiment of the present disclosure. The lighting arrangement 10b includes a mounting ring 12b. A covering ring 38b is also illustrated. The lighting arrangement 10b includes an alternative housing assembly 34b that does not protrude above the mounting ring 12b. The housing assembly 34b can include all of the components contained in the housing assembly 36 and the housing 36 of the first embodiment.

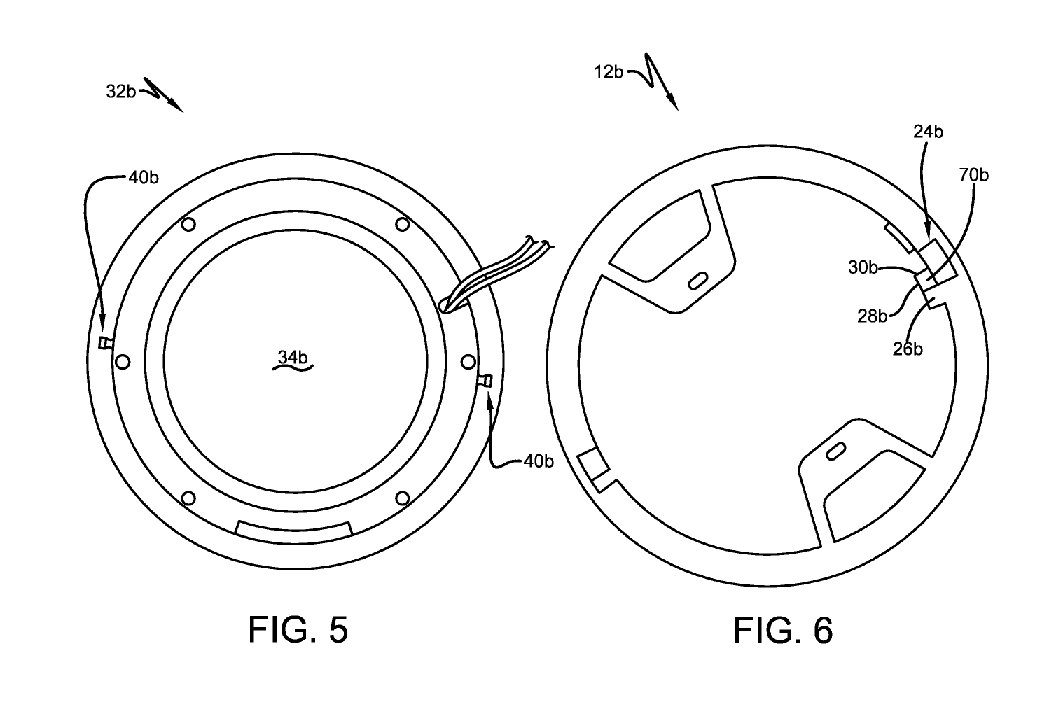

FIG. 5 is a top view of a lighting assembly 32b according to an exemplary embodiment of the present disclosure. The exemplary lighting assembly 32b is a component of the exemplary lighting arrangement 10b shown in FIG. 4. FIG. 6 is a top view of the mounting ring 12b according to an exemplary embodiment of the present disclosure.

With reference to FIGS. 4-6, the mounting ring 12b can extend along a central longitudinal axis 58b and have a plurality of tabs, such as tab 18b. The mounting ring 12b can also have a circular wall 14b and a plurality of locking arms 24b. Each of the plurality of tabs 18b can define a mounting aperture, such as mounting aperture 22b. The circular wall 14b can interconnect the plurality of tabs 18b. The circular wall 14b can have an inwardly-facing surface 60b encircling the axis 58b and defining a cavity 62b. The circular wall 14b can also have an outwardly-facing surface 64b opposite the inwardly-facing surface 60b with a thickness defined between the inwardly-facing surface 60b and the outwardly-facing surface 64b. The circular wall 14b can extend a height along the axis 58b between a downwardly-facing surface 66b and an upwardly-facing surface 68b. Each of the plurality of circumferentially-extending locking arms 24b can project from the circular wall 14b radially relative to the axis 58b. Each of the plurality of locking arms 24b can include a vertical portion 26b extending along the axis 58b and a circumferential portion 28b extending about the axis 58b. Each of the circumferential portions 28b can extend from a first end at an intersection with one of the vertical portions 26b to a respective second end 30b distal relative to the first end. Each of the circumferential portions 28b can have an upper face 70b and a lower face (not visible in FIGS. 4-6). Each face can be defined by a plurality of discrete surfaces in one or more implementations of the present disclosure. The luminaire 32b can include the housing assembly 34b, one or more light emitters (not visible), and a plurality of posts 40b. The housing assembly 34b can at least partially enclose the light emitter. The exemplary housing assembly 34b can be fully received in the cavity 62b. Each of the plurality of posts 40b can extend away from the housing assembly 34b. The mounting ring 12b and the luminaire 32b can be interconnected by moving each of the plurality posts 40b past each of the plurality of distal ends 30b along the axis 58b and rotating the mounting ring 12b and the luminaire 32b relative to one another in a first angular direction about the axis 58b.

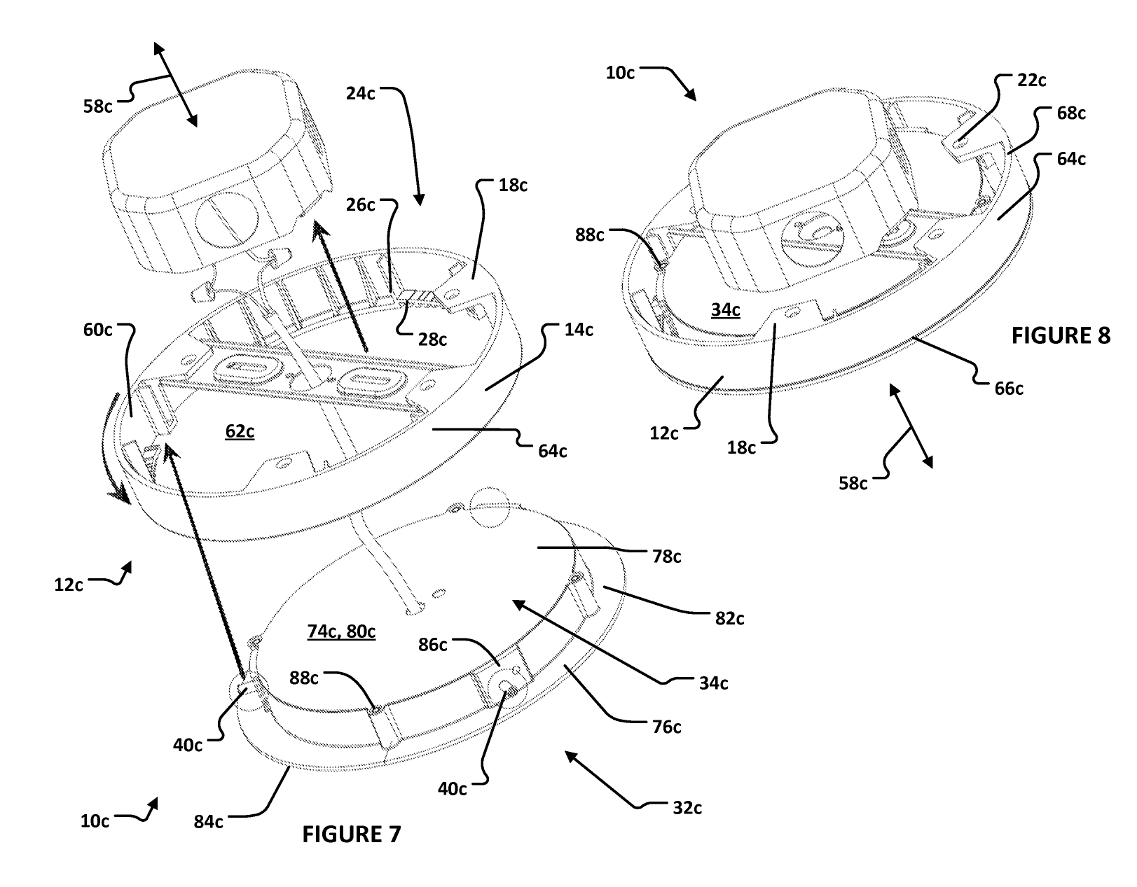

In other embodiment of the present disclosure, shown in FIGS. 7-9, a lighting arrangement 10c can include a mounting ring 12c and a luminaire 32c. The mounting ring 12c can extend along a central longitudinal axis 58c and have a plurality of tabs 18c. The mounting ring 12c can also have a circular wall 14c and a plurality of locking arms 24c. Each of the plurality of tabs 18c can define a mounting aperture 22c. The circular wall 14c can interconnect the plurality of tabs 18c. The circular wall 14c can have an inwardly-facing surface 60c encircling the axis 58c and defining a cavity 62c. The circular wall 14c can also have an outwardly-facing surface 64c opposite the inwardly-facing surface 60c with a thickness defined between the inwardly-facing surface 60c and the outwardly-facing surface 64c. The circular wall 14c can extend a height along the axis 58c between a downwardly-facing surface 66c and an upwardly-facing surface 68c.

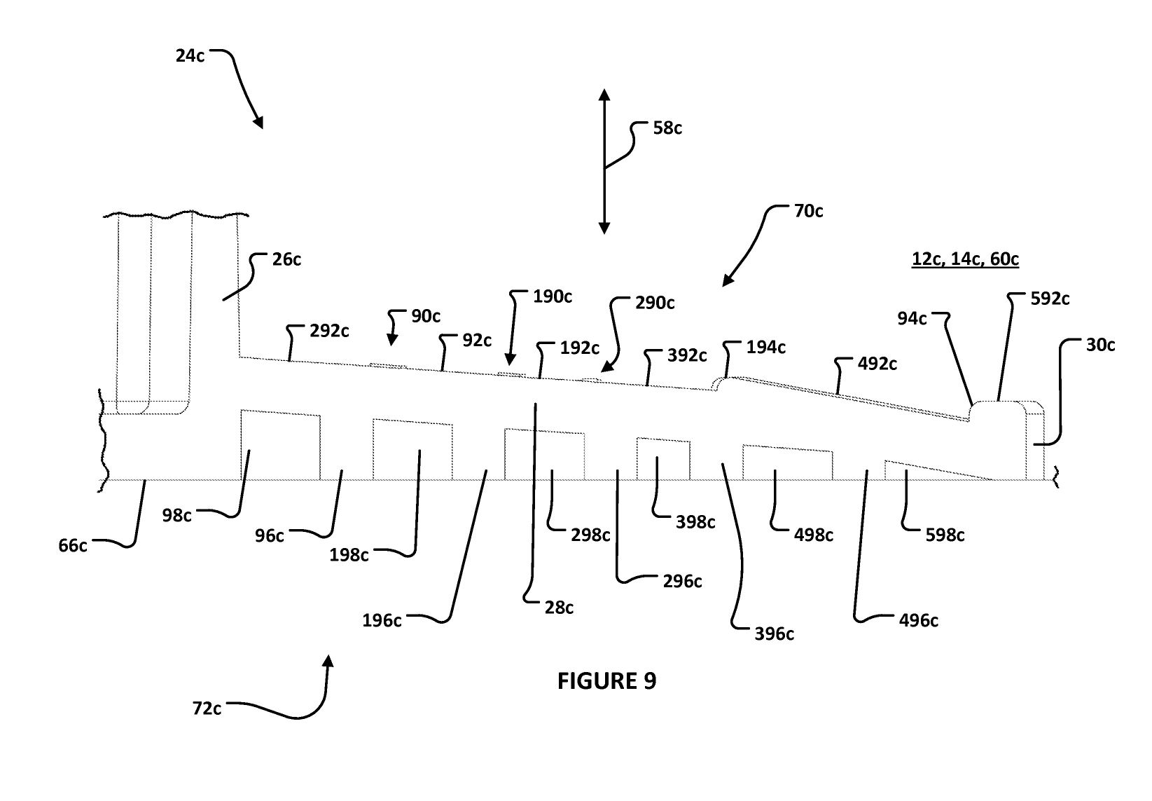

As best shown in FIG. 9, each of the plurality of circumferentially-extending locking arms 24c can project from the circular wall 14c radially relative to the axis 58c. The exemplary arms 24c project radially inward, but could project radially outward in other implementations of the present disclosure. Each of the plurality of locking arms 24c can include a vertical portion 26c extending along the axis 58c and a circumferential portion 28c extending about the axis 58c. Each of the circumferential portions 28c can extend from a first end at an intersection with one of the vertical portions 26c to a respective second end 30c distal relative to the first end. Each of the circumferential portions 28c can have an upper face 70c and a lower face 72c. Each face 70c, 72c can be defined by a plurality of discrete surfaces in one or more implementations of the present disclosure.

The luminaire 32c can have a housing assembly 34c and a light emitter and a plurality of posts 40c. The housing assembly 34c can at least partially enclose the light emitter. The exemplary housing assembly 34c can be fully received in the cavity 62c. Each of the plurality of posts 40c can extend away from the housing assembly 34c. The mounting ring 12c and the luminaire 32c can be interconnected by moving each of the plurality posts 40c past each of the plurality of distal ends 30c along the axis 58c and rotating the mounting ring 12c and the luminaire 32c relative to one another in a first angular direction about the axis 58c.

The exemplary housing assembly 34c can include a body portion 74c having a covering ring or flange portion 76c. The body portion 74c can extend between top end 78c and a bottom end along the axis 58c. The exemplary body portion 74c is fully disposed in the cavity 62c. The body portion 74c can extend along the axis 58c between the downwardly-facing surface 66c of the circular wall 14c and the plurality of tabs 18c. The body portion 74c can have a variable thickness, with thicker portions (such as referenced at 86c) surrounding each of the plurality of posts 40c. The flange portion 76c can extend radially-outward from the body portion 74c and having an upwardly-facing surface 82c and a downwardly-facing surface 84c. The upwardly-facing surface 82c of the flange portion 76c can abut and contact the downwardly-facing surface 66c of the circular wall 14c around a continuous circumference about the axis 58c, as shown in FIG. 8. A diameter of the flange portion 76c can be substantially equal to a diameter of the outwardly-facing surface 64c of the circular wall 14c and thus flush with the outwardly-facing surface 64c.

The exemplary housing assembly 34c can also include a canister portion 80c positioned in the body portion 74c. The light emitters can be disposed in the canister portion 80c. The canister portion 80c and the body portion 74c can be interconnected with fasteners 88c.

FIG. 9 is a planar view of the locking arm 24c from the perspective of the central longitudinal axis 58c. As shown, the exemplary upper face 70c defines a serrated profile. The illustration of the profile 24c shows a series of notched edges, a plurality of distinct surfaces delineated by distinct edges. The exemplary edges are defined by a plurality of protuberances 90c, 190c, 290c, with planar surface portions 92c, 192c defined between adjacent pairs of protuberances and other planar surface portions 292c, 392c, 492c, 592c.

The posts 40c can ride along the upper face 70c during assembly of the lighting arrangement 10c. The engagement between the posts 40c and the protuberances 90c, 190c, 290c and the surfaces 92c, 192c, 292c, 392c, 492c, 592c provide the assembler (typically a consumer) during relative rotation between the lighting arrangement 32c and the mounting ring 12c, allows the assembler to feel progress of assembly. Further, the arrangement of the protuberances 90c, 190c, 290c and the surfaces 92c, 192c, 292c, 392c, 492c, 592c allow the lighting arrangement 32c to be positioned in a plurality of different angular positions relative to the mounting ring 12c. In the Figures, the lighting arrangement 32c is unadorned, but embodiments can be practiced with decorative features and indicia and a precise angular of the lighting arrangement 32c relative to the mounting ring 12c can be desirable. Engagement between the posts 40c and the protuberances 90c, 190c, 290c can generate a click or another noise so that the assembler is advised of progress or advised of one possible “final” position for the lighting arrangement 32c. For example, the first click can inform the assembler that the lighting arrangement 32c is acceptably engaged with the mounting ring 12c. The assembler can further rotate the lighting arrangement 32c if desired. Embodiments can include more than three protuberances 90c, 190c, 290c. The gaps between protuberances 90c, 190c, 290c (the circumference length of the surface portions 92c, 192c) can be constant or variable. For example, the gaps can shorten as rotation of the lighting arrangement 32c progresses.

The upper face 70c can also include a plurality of surface portions 94c, 194c that are concave relative to the first angular direction. The direction of assembly rotation for an exemplary embodiment is referenced at 96c. Specifically, in one or more embodiments, the mounting ring 12c can be fixed and the lighting arrangement 32c can be rotated in the direction 96c to engage the lighting arrangement 32c with the mounting ring 12c. The post 40c can ride along the surface portion 592c of the upper face 70c during assembly of the lighting arrangement 10c and ride over the 94c which is concave relative to the direction 96c. The movement of the post 40c over the surface portion 94c can generate a pronounced click or hand-feel. The concave surface portions 94c, 194c along with the protuberances 90c, 190c, 290c can cause different noises or tactile sensations that can assist the assembler during assembly. The surface portion 94c is fed by the flat surface portion 592c. The surface portion 194c is fed by the ramp surface portion 492c. Thus, order of flat and concave surface portions can be varied to simplify installation for the assembler.

The lower face 72c of the locking arm 24c defines a stepped profile. The stepped profile includes a plurality of steps 96c, 196c, 296c, 396c, 496c and a plurality of gaps 98c, 198c, 298c, 398c, 498c, 598c between adjacent steps. The circumferential width of the steps 96c, 196c, 296c, 396c, 496c can be variable or constant. The circumferential width of the gaps 98c, 198c, 298c, 398c, 498c, 598c can be variable or constant. It can be desirable to vary the circumferential widths in that variation can provide an indication of the distal end 30 for the assembler. The mounting ring 12c can be installed in a wall or ceiling and the pattern of steps and gaps can provide an indication to the assembler of the location of the locking arms 24c. In the exemplary embodiment, the widths of gaps 498c and 598c are greater than the width of gaps 98c, 198c, 298c, and 398c. Further the width of gap 398c is less than the widths of the remaining gaps 198c, 298c, 398c, 498c, 598c. The mounting ring 12c can be formed such that downwardly-facing surface 66c is planar and uninterrupted except for the pattern of gaps 98c, 198c, 298c, 398c, 498c, 598c to assist the assembler in quickly and easily identifying the location for inserting the posts 40c.

The arrangement of the steps 96c, 196c, 296c, 396c, 496c and the gaps 98c, 198c, 298c, 398c, 498c, 598c renders the thickness of the plurality of locking arms 24, as defined along the axis 58c, to be variable. This allows for some bending of the locking arm 24c during installation. Bending of the locking arm 24c can enhance the tactile or noise response when the posts 40c engage features of the upper face 70c.

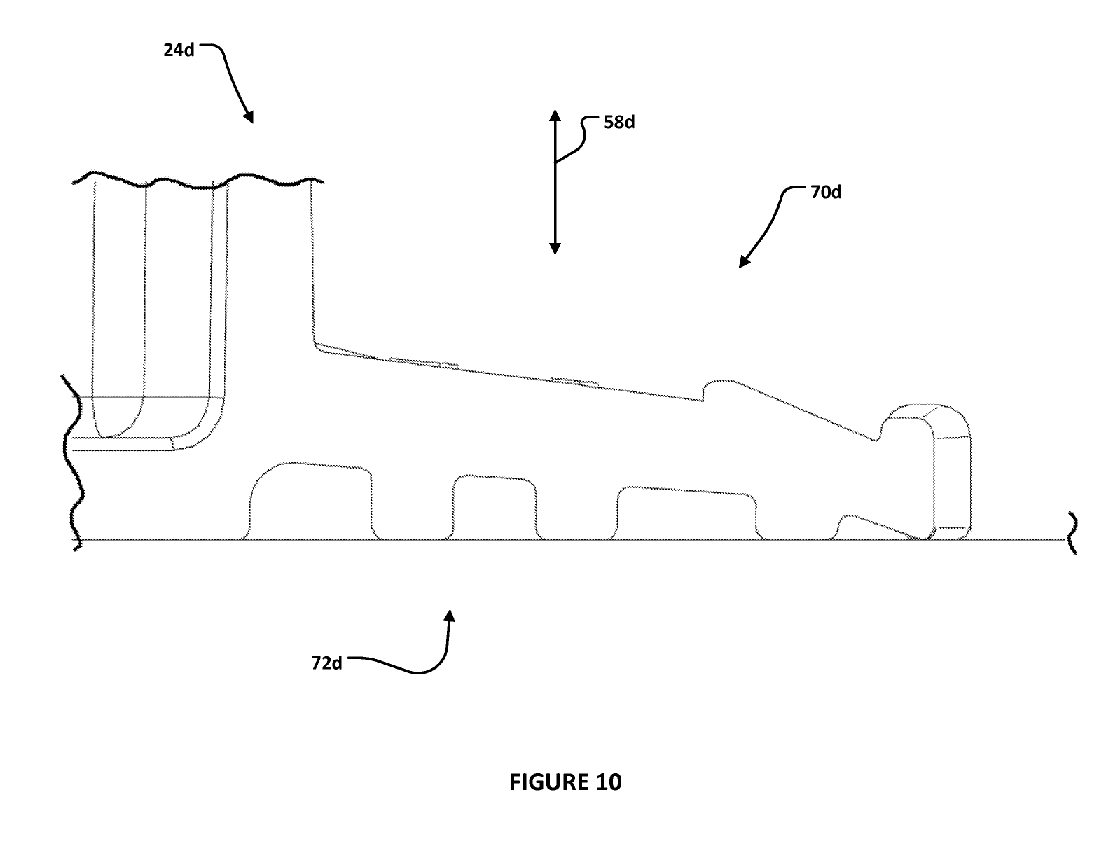

FIG. 10 is a planar view of a locking arm 24d of another exemplary embodiment of the present disclosure from the perspective of a central longitudinal axis 58d. The locking arm 24d includes an upper face 70d and a lower face 72d. The upper face 70d defines a plurality of discreet planar surfaces with edges defined between the surfaces. The locking arm 24d defines a more compact upper face 70d than the upper face 70c.

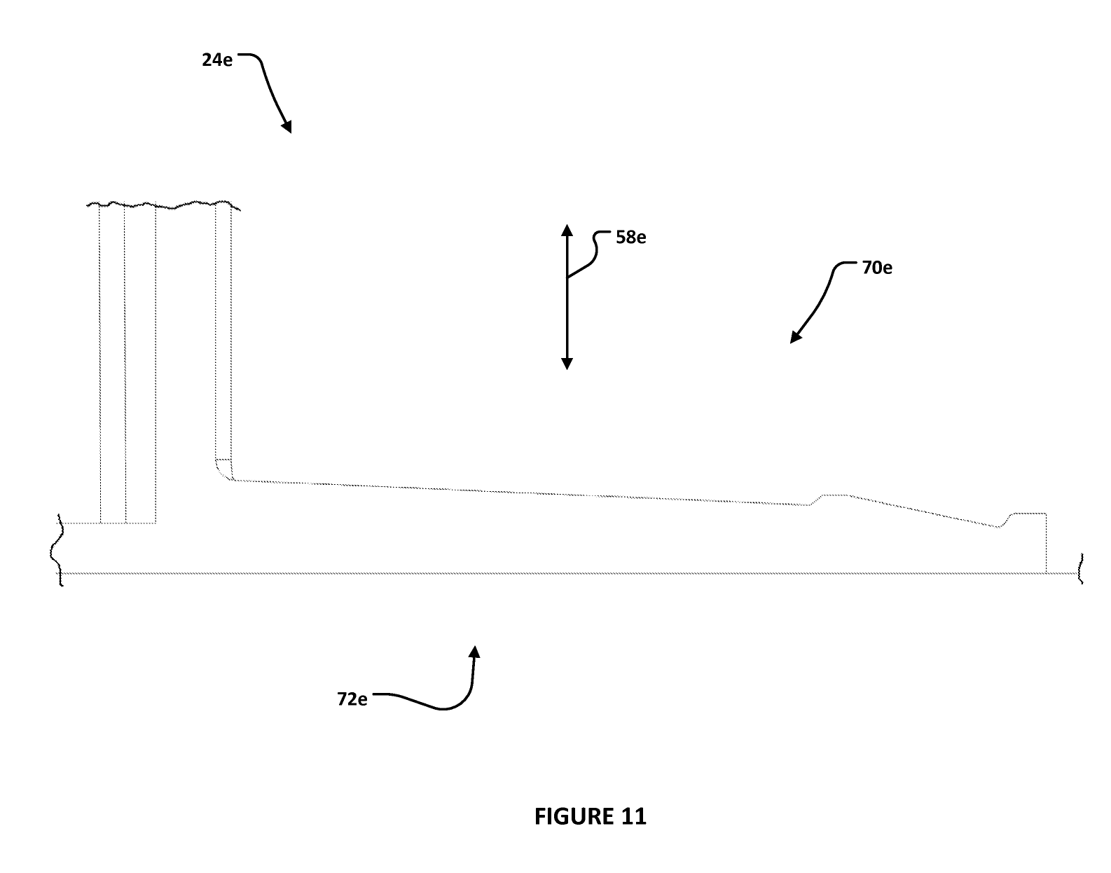

FIG. 11 is a planar view of a locking arm 24e of another exemplary embodiment of the present disclosure from the perspective of a central longitudinal axis 58e. The locking arm 24e includes an upper face 70e and a lower face 72e. The upper face 70e defines a plurality of discreet planar surfaces with edges defined between the surfaces. The upper face 70e does not include protuberances but is longer than the upper face 70c and defines ramped surface portions of smaller slope that the ramp surface portions 392c, 492c of the upper face 70c. This profile can be desirable in that it provides a surface more amenable to infinite, stable positioning, since the posts cannot be positioned on the precise edges of protuberances and steep ramps can tend to urge the posts down the ramp surface.

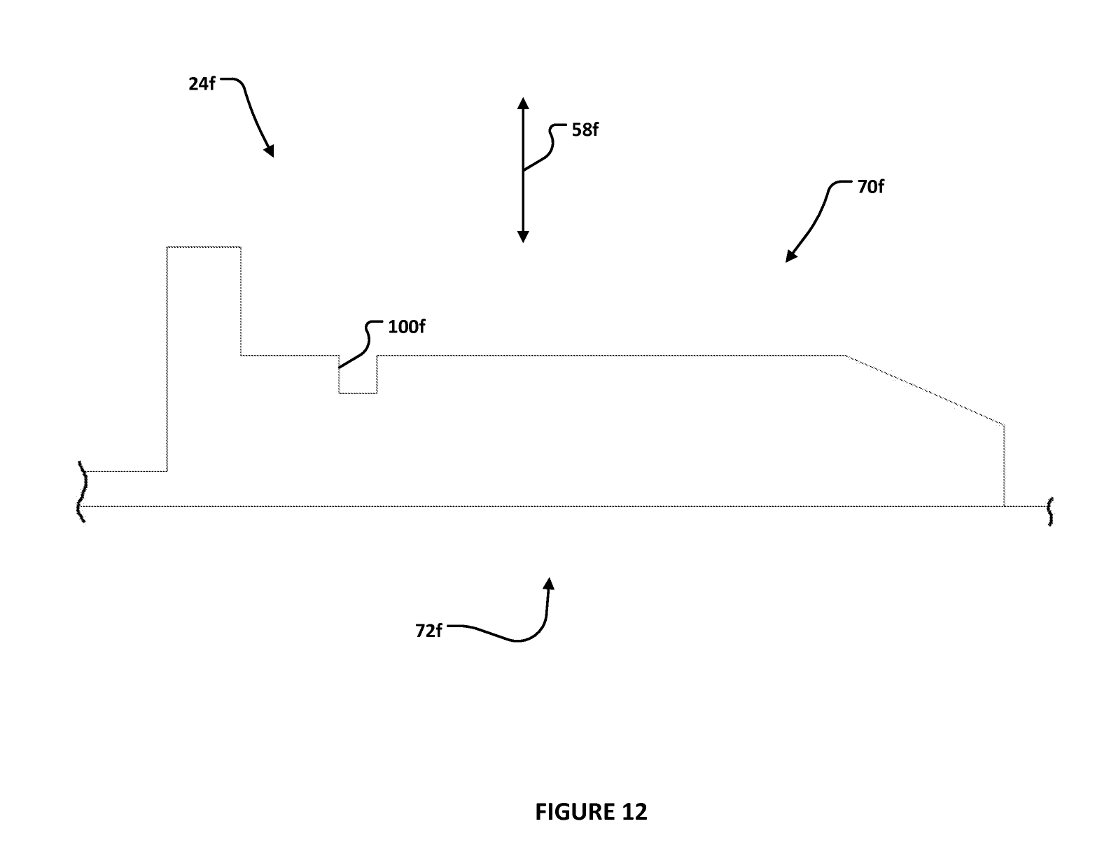

FIG. 12 is a planar view of a locking arm 24f of another exemplary embodiment of the present disclosure from the perspective of a central longitudinal axis 58f. The locking arm 24f includes an upper face 70f and a lower face 72f. The upper face 70f defines a plurality of discreet planar surfaces with edges defined between the surfaces. The upper face 70f also defines a notch 100f for receiving and capturing a post.

Referring again to FIGS. 7-9, the exemplary posts 40c extend only radially outward from the axis 58c. Alternatively, the posts 40 of the embodiment show in FIGS. 1 and 2 extend in multiple directions relative to the axis 58. The posts 40 extend upward along the axis 58 a first predetermined distance and circumferentially a second predetermined distance about the axis 58.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A lighting arrangement comprising:
a mounting ring extending along a central longitudinal axis and having a plurality of tabs and a circular wall and a plurality of locking arms, each of said plurality of tabs defining a mounting aperture, said circular wall interconnecting said plurality of tabs, said circular wall having an inwardly-facing surface encircling said axis and defining a cavity, said circular wall also having an outwardly-facing surface opposite said inwardly-facing surface with a thickness defined between said inwardly-facing surface and said outwardly-facing surface, said circular wall extending a height along said axis between a downwardly-facing surface and an upwardly-facing surface, each of said plurality of locking arms projecting from said circular wall radially relative to said axis, each of said plurality of locking arms including a vertical portion extending along said axis and a circumferential portion extending about said axis, each of said circumferential portions extending from a first end at an intersection with one of said vertical portions to a respective second end distal relative to said first end, and each of said circumferential portions having an upper face and a lower face;
a luminaire having a housing assembly and a light emitter and a plurality of posts, said housing assembly at least partially enclosing said light emitter, said housing assembly at least partially received in said cavity, each of said plurality of posts extending away from said housing assembly; and
wherein said mounting ring and said luminaire are interconnected by moving each of said plurality posts past each of said plurality of distal ends along said axis and rotating said mounting ring and said luminaire relative to one another in a first angular direction about said axis.

2. The lighting arrangement of claim 1 wherein said housing assembly further comprises:
a body portion extending between top and bottom ends along said axis; and
a flange portion extending radially-outward from said body portion and having an upwardly-facing surface and a downwardly-facing surface, wherein said upwardly-facing surface of said flange portion abuts and contacts said downwardly-facing surface of said circular wall.

3. The lighting arrangement of claim 2 wherein said upwardly-facing surface of said flange portion abuts and contacts said downwardly-facing surface of said circular wall around a continuous circumference about said axis.

4. The lighting arrangement of claim 3 wherein said body portion is fully disposed in said cavity.

5. The lighting arrangement of claim 4 wherein a diameter of said flange portion is substantially equal to a diameter of said outwardly-facing surface of said circular wall.

6. The lighting arrangement of claim 3 wherein said body portion extends along said axis between said downwardly-facing surface of said circular wall and said plurality of tabs.

7. The lighting arrangement of claim 2 wherein said housing assembly further comprises:
a canister portion positioned in said body portion, wherein said light emitter is disposed in said canister portion.

8. The lighting arrangement of claim 7 wherein said canister portion and said body portion are interconnected with fasteners.

9. The lighting arrangement of claim 2 wherein said body portion has a variable thickness with thicker portions surrounding each of said plurality of posts.

10. The lighting arrangement of claim 1 wherein at least one of said upper faces defines a serrated profile.

11. The lighting arrangement of claim 1 wherein at least one of said upper faces is defined by a plurality of surfaces delineated by at least one distinct edge.

12. The lighting arrangement of claim 1 wherein at least one of said upper faces includes a plurality of protuberances and planar surface portions between said plurality or protuberances.

13. The lighting arrangement of claim 1 wherein at least one of said upper faces includes a plurality of surface portions that are concave relative to the first angular direction.

14. The lighting arrangement of claim 1 wherein said plurality of locking arms extend from said inwardly-facing surface of said circular wall.

15. The lighting arrangement of claim 1 wherein at least one of said lower faces defines a stepped profile.

16. The lighting arrangement of claim 15 wherein said stepped profile further comprises a plurality of steps and a plurality of gaps between adjacent steps, where a circumferential width between said plurality of gaps is variable.

17. The lighting arrangement of claim 1 wherein a thickness of said plurality of locking arms is defined along said axis and is variable.

18. The lighting arrangement of claim 1 wherein said plurality of posts extend only radially outward from said axis.

19. The lighting arrangement of claim 1 wherein said plurality of posts extend in multiple directions relative to said axis.

20. The lighting arrangement of claim 19 wherein said plurality of posts extend along said axis and circumferentially about said axis.
